(19) United States
(12) Patent Application Publication
(10) Pub. No.: US 2020/0051103 A1
(43) Pub. Date: Feb. 13, 2020

(54) ACTIVITY OPERATING SYSTEM ADAPTED TO MAZE-LIKE SHOPPING STREETS

(71) Applicant: YING-HSUAN CHIU, New Taipei City (TW)

(72) Inventor: YING-HSUAN CHIU, New Taipei City (TW)

(21) Appl. No.: 16/505,016

(22) Filed: Jul. 8, 2019

(30) Foreign Application Priority Data
Jul. 6, 2018 (TW) 107123780

(51) Int. Cl. G06Q 30/02; H04L 12/58; H04W 4/021

(52) U.S. Cl. CPC G06Q 30/0209; H04W 4/021; H04L 51/20

(57) ABSTRACT

An activity operating system adapted to maze-like shopping street is proposed. The system mainly comprises: publishing activity information via internet, with said information comprising activity items comprising a shopping street, stores, products, advertisements involved in an activity; receiving registrations of participators and stores via internet for a predetermined time slot; informing the participators and the stores of activity contents generated based on an actual situation, wherein the actual situation is produced according to the registered participators and stores in the registration step, and the activity contents to be informed include time, rules and route of the activity, as well as the prizes; and, at the time that the activity is carried out, informing the participators and the stores by instant messaging, detecting locations and moving routes of the participators, receiving check-in messages and instant pictures from the participators, and providing the participators with winners list.

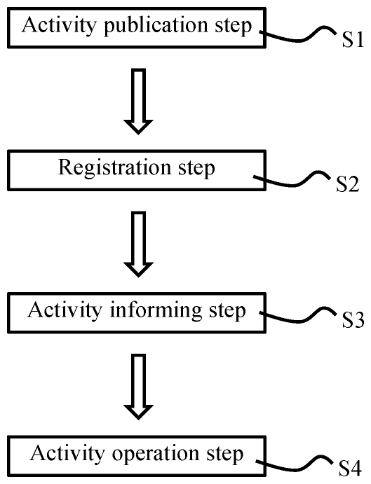

### BACKGROUND OF THE INVENTION

### (1) Field of the Invention

The present invention is related to an activity operating system, especially to the activity operating system adapted to maze-like shopping streets.

### (2) Description of Related Art

With the growth of a city, the topology of the shopping streets thereof falls into an over-developed situation. With the existence of the over-developed situation, information and ADs shown in the streets become too much and messy, and thus result in a huge chaos relationship between store owners and consumers due to a complex operation of the shopping streets. Not only the consumers cannot accurately get the shopping information, but also the store owners cannot efficiently provide ADs and operate. Namely, desired products cannot be offered by suitable stores, and good stores cannot attract consumers efficiently.

Taking the shopping streets in subway stations, shopping arcades, huge shopping malls etc. as examples, consumers therein often fool around and shopping aimless because they are not familiar with the topology thereof, and this may even cause a delayed schedule or a missed date. Apparently, it is time consuming and inefficient.

Furthermore, when the stores want to promote new products or foods, the promotion thereof cannot be easily carried out unless the consumers have a chance to experience them by themselves. Therefore, a conventional way is to hire a star or ADs which costs a lot of money for promoting said new products or foods. However, the actual efficiency is usually limited. The main reason is that the major group of consumers may not have the chance to be at the location of the store, and people having time for shopping may not have chance to see the information of the promotion. Therefore, a system able to focus the attentions of the consumers is needed for the consumers and the store owners.

### BRIEF SUMMARY OF THE INVENTION

An activity operating system adapted to maze-like shopping street is proposed. The system comprises: an activity publication step publishing activity information via internet, with said information comprising activity items comprising a shopping street, stores, products, advertisements involved in an activity; a registration step, after the activity publication step is finished, receiving registrations of participators and stores via internet for a predetermined time slot, wherein the participators selectively provide social media information required by the activity, and wherein the stores selectively provide fee schedules and prizes to be given, as well as contents of specific matters; an activity informing step, after the registration step is finished, informing the participators and the stores of activity contents generated based on an actual situation, wherein the actual situation is produced according to the registered participators and stores in the registration step, and the activity contents to be informed include time, rules and route of the activity, as well as the prizes; and an activity operation step, after the activity informing step, performing actions at the time that the activity is carried out at least, wherein the actions comprises: informing the participators and the stores by instant messaging, detecting locations and moving routes of the participators, receiving check-in messages and instant pictures from the participators, and providing the participators with winners list.

### BRIEF DESCRIPTION OF THE DRAWINGS

It should be noted that the drawing FIGURES may be in simplified form and might not be to precise scale. In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner.

The sole FIGURE is a flow chart of a preferable embodiment of the present disclosure.

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

The present disclosure relates to an active operating system adapted to maze-like shopping streets, and especially directs to a business operating system for consumers to register through a cloud server mainly having the following operation characters.

An activity publication step S1 is performed, which comprises publishing activity information via internet. Said information may include the shopping streets, stores, products, ADs etc. involved in the activity, which serve as activity items. The activity items may further link to specific matters, such as foods, products, ADs, claw machines, extinguishers, lockers, chargers, particular pictures, items, customer centers, VIP rooms, cash machines, photo booths, invited public FIGURES, etc. Namely, the activity events of a single activity may relate to products, fields or people possibly contacted with tourists, so as to provide the fun of treasure hunting.

A registration step S2 is then performed. After the activity publication step S1 is finished, a predetermined time slot is opened for receiving the registrations of participators and stores via internet. Specifically, participators may provide their social media information required by the activity, and the stores may provides the fee schedules and prizes to be given, as well as the contents of the specific matters.

An activity informing step S3 is also performed. After the registration step S2 is finished, the participators and the stores are informed of activity contents generated based on an actual situation, wherein the actual situation is produced by the system according to the confirmed participators and stores mentioned in the registration step S2. The informed activity contents include the time, rules and route of the activity, as well as the prizes for events.

Finally, an activity operation step S4 is performed. After the activity informing step S3, at the time that the activity is carried out, at least the following actions are performed, which include: informing the participators and the stores by instant messaging, detecting locations and moving routes of the participators, receiving the check-in messages and instant pictures from the participators, and providing the participators with the winners list.

For clearly illustrating the operating system of the present disclosure, an example is shown as follows. After the activity publication step S1 and the registration step S2 are finished, the activity informing step S3 will provide the participators and the stores with the activity contents on the day that the activity takes place. The participators may start to register at the specific time and location on the shopping streets. The operating system may transfer information includes the locations where activity events are carried out and the suggested routes via internet. The participators may go to each location to join the events and upload pictures related to the events to his/her social media webpage to publish information of the events, so that the participators can earn the prize after the events are finished.

According to the above embodiments, there are advantages as the follows. With the present operating system, through the pictures related to the activity and uploaded by the participators on their social media webpages, the information of the shopping streets can be spread fast and widely, and the stores involve in the activity can increase their reputation quickly. Furthermore, with the instant response to the activity on the internet, the system may attract relatives and friends of participators to join the events. Moreover, with the provided prizes, the consumptions in the shopping streets having the activity can be stimulated. The consumers in need of some products may easily find the information of specific stores and actual locations thereof via the publishing of the event locations. With the prearranged routes, the costumers as the participators may get familiar with the complex topology of the shopping street when searching items or guided by the electronic maps. With the stimulation of competition, more participators will come to join the following activities and a trend may be formed. More consumers may actually experience the products, foods, and services provided by the stores through participation in the activity. Therefore, the stores supporting the activity can get efficient advertising effects.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and de+scribed above, what is conceptually equivalent, what can be obviously substituted and also what essentially incorporates the essential idea of the invention.

What is claimed is:

1. An activity operating system adapted to maze-like shopping street, comprising:
an activity publication step publishing activity information via internet, with said information comprising activity items comprising a shopping street, stores, products, advertisements involved in an activity;
a registration step, after the activity publication step is finished, receiving registrations of participators and stores via internet for a predetermined time slot, wherein the participators selectively provide social media information required by the activity, and wherein the stores selectively provide fee schedules and prizes to be given, as well as contents of specific matters;
an activity informing step, after the registration step is finished, informing the participators and the stores of activity contents generated based on an actual situation, wherein the actual situation is produced according to the registered participators and stores in the registration step, and the activity contents to be informed include time, rules and route of the activity, as well as the prizes; and
an activity operation step, after the activity informing step, performing actions at the time that the activity is carried out at least, wherein the actions comprises: informing the participators and the stores by instant messaging, detecting locations and moving routes of the participators, receiving check-in messages and instant pictures from the participators, and providing the participators with winners list.

2. The activity operating system adapted to maze-like shopping street as claimed in claim 1, wherein the activity items link to the specific matters, with said specific matters comprising at least one of foods, products, advertisements, claw machines, extinguishers, lockers, chargers, particular pictures, items, customer centers, VIP rooms, cash machines, photo booths, and invited public FIGURES, which relate to products, fields or people contacted with tourists.
